(19) United States
(12) Patent Application Publication
(10) Pub. No.: US 2008/0074777 A1
(43) Pub. Date: Mar. 27, 2008

(54) Magnetic Recorder/Reproducer

(76) Inventor: Toshio Fukazawa, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/662,135

(22) PCT Filed: Sep. 6, 2005
(86) PCT No.: PCT/JP05/16292

§ 371 Date: Mar. 8, 2007

(30) Foreign Application Priority Data
Sep. 29, 2004 (JP) 2004-283848

(51) Int. Cl. G11B 5/58

(52) U.S. Cl. 360/77.01

(57) ABSTRACT

A magnetic recording and reproducing apparatus of the invention comprises a measuring unit for measuring a space between a recording head and a reproducing head, a detecting unit for detecting a position of a front one of record magnetization reversal units in a data domain, and a recording unit for recording in a corresponding manner with the record magnetization reversal units. The magnetic recording and reproducing apparatus of this structure can perform excellent recording on a patterned medium by virtue of providing a proper timing from the front record magnetization reversal unit.

### TECHNICAL FIELD

The present invention relates to a magnetic recording and reproducing apparatus used for magnetic recording.

### BACKGROUND ART

There has been a drastic increase in recent years in areal recording densities of magnetic recording apparatuses, especially of hard disk drives. Such an increase in the areal recording density can be achieved by miniaturizing an area of each record magnetization reversal unit. With this trend of miniaturizing record magnetization reversal units, there are demands for fining down sizes of grains in magnetic recording layers to substantially smaller than that of the record magnetization reversal units in order to reduce transition noises between the adjacent record magnetization reversal units.

Fining down in sizes of the grains in magnetic recording layers is synonymous with a decrease in volume of the magnetic grains, however, that a problem of thermal fluctuations surfaces as the volume of the magnetic grains decreases. This gives rise to a problem of not only rendering recorded information thermally unstable, but also increasing noises attributable to recording obscurity in adjacent tracks caused by a fringe magnetic field of a recording head.

There have been some proposals for patterned media devised to avoid the above problem, in which a magnetic layer in a magnetic recording medium is separated into single-bit units of independent form by providing a non-magnetic substance between adjacent record magnetization reversal units. This technique is disclosed in, for example, Japanese Patent Unexamined Publication, No. H03-22211 (hereinafter referred to as “Patent Document 1”).

The record magnetization reversal units separated to be independent in this manner can improve tolerance to thermal fluctuations since these record magnetization reversal units can be considered as individual grains having a large volume in the magnetic recording layer.

In the patterned media discussed here, it is necessary to apply a magnetic field of a recording head in synchronization with the record magnetization reversal units when recording information, because the record magnetization reversal units are formed stationary on a magnetic recording medium.

One of methods for applying a recording magnetic field to record magnetization reversal units with proper timing is disclosed in, for example, Japanese Patent Unexamined Publication, No. 2003-281701 (hereinafter “Patent Document 2”).

Referring now to FIG. 5, description is provided of a conventional magnetic recording and reproducing apparatus detailed in Patent Document 2, and how it operates.

FIG. 5 is a sectional view showing a structure of the conventional magnetic recording and reproducing apparatus. In FIG. 5, magnetic recording medium 511 has a plurality of record magnetization reversal units 512 formed in a manner that they are separated from one another by non-magnetic domains 513. There is soft magnetic layer 515 formed under the record magnetization reversal units with separation layer 514 placed therebetween. Fixture 51 equipped with a magnetic data writing means of single-pole head 516a is provided above magnetic recording medium 511. Reference mark 516b denotes an insulation layer, reference marks 518a and 518b denote a spiral coil for generating a magnetic field, and reference mark 517 denotes a return path which constitutes a magnetic circuit. Reference mark 51b denotes a magnetic flux passing through the magnetic circuit, and reference mark 51d denotes a leak magnetic field.

GMR head 519 representing a magnetic sensor for reading signals obtains a signal that indicates whether information has been written in record magnetization reversal unit 512. GMR head 519 is fixed to fixture 51 at a predetermined distance away from single-pole head 516a, and enclosed in magnetic shield 51a. Single-pole head 516a and GMR head 519 travel in a direction shown by arrow 51c.

An amount of leak magnetic field 51d varies during recording operation between a condition of proper timing, in which a downward magnetic field applied by single-pole head 516a downwardly magnetizes record magnetization reversal unit 512 underneath thereof to form a magnetic circuit among soft magnetic layer 515 and return path 517, and another condition of improper timing, in which a magnetic circuit is not properly formed through soft magnetic layer 515 and return path 517. The amount of leak magnetic field 51d increases in the condition of improper timing.

Leakage flux 51d is detected by GMR head 519, and upon detecting leakage flux 51d of such an amount as to be out of the proper timing, control unit 53 causes timing controller 54 to generate a signal for shifting a phase of the application timing of the magnetic field.

In other words, detect signal processing unit 52 proceeds with processing of the signal detected for the leak magnetic field, etc., and control unit 53 causes timing controller 54 to operate based on a result obtained from the processed signal in a manner that timing controller 54 controls the timing of single-pole head 516a to generate the magnetic field for writing information correctly.

The above function is capable of detecting a writing failure in a very short time, and reducing a number of record magnetization reversal units that carry faulty writing by way of correcting the writing timing.

According to the conventional technique discussed above, it is possible to detect slippage in the write timing during the recording operation. It is necessary, however, that the recording operation be repeated again when the timing is found slipped.

In the case of a magnetic recording and reproducing apparatus of such kind as hard disk drive, in particular, a magnetic recording medium has servo domains and data domains arranged thereon, in which the apparatus reproduces a magnetized pattern arrayed in the servo domains, and moves a magnetic head to a predetermined track to record in or reproduce from the data domains. In the conventional example discussed above, however, no technique has been disclosed of how to detect a starting position of the record magnetization reversal units to be recorded when start writing on the data domains after the magnetic head is moved to the predetermined track according to information of the servo domains. This leaves a possibility of causing an out-of-timing for writing in the record magnetization reversal units immediately after the start, and thereby making it necessary to repeat writing again.

Since the magnetic recording medium normally has a plurality of servo domains arrayed on its circumference, there remains a problem that recording failures are likely to occur frequently at a leading sector in the data domains.

### SUMMARY OF THE INVENTION

The present invention is directed to overcome the above problems of the conventional art, and it is therefore an object of this invention to provide a magnetic recording and reproducing apparatus which is capable of performing excellent recording in record magnetization reversal units in data domain s from the very first ones.

To overcome the above problems, the magnetic recording and reproducing apparatus of this invention has a magnetic recording medium provided with a magnetic recording layer, which is separated regularly by a non-magnetic layer into number of record magnetization reversal units and arrayed at least along a lengthwise direction of a recording track. The magnetic recording and reproducing apparatus further comprises a measuring unit for measuring a space between a recording head and a reproducing head, a detecting unit for detecting a position of a front one of the record magnetization reversal units in a data domain with the reproducing head, and a recording unit for recording in a corresponding manner with the record magnetization reversal units.

According to the present invention, the magnetic recording and reproducing apparatus can carry out excellent recording on patterned media by detecting a recording timing from the front record magnetization reversal unit, thereby avoiding undesired rerecording as discussed above.

### BRIEF DESCRIPTION OF DRAWINGS

FIG. 1A is a general schematic showing a vertical magnetization recording medium of a magnetic recording and reproducing apparatus according to an exemplary embodiment of the present invention;

FIG. 1B is another general schematic showing the vertical magnetization recording medium of the magnetic recording and reproducing apparatus according to the exemplary embodiment of the present invention;

FIG. 1C is another general schematic showing the vertical magnetization recording medium of the magnetic recording and reproducing apparatus according to the exemplary embodiment of the present invention;

FIG. 2A is a general schematic showing a measuring unit for measuring a space between a recording head and a reproducing head according to the exemplary embodiment of the present invention;

FIG. 2B is another general schematic showing the measuring unit for measuring the space between the recording head and the reproducing head according to the exemplary embodiment of the present invention;

FIG. 3 is a graphic representation showing changes with time in amplitude of a recording current and a reproduced signal taken in the measuring unit for measuring the space between the recording head and the reproducing head according to the exemplary embodiment of the present invention;

FIG. 4 is a general schematic showing a detecting unit for detecting a position of a front one of record magnetization reversal units in a data domain, and a recording unit for recording in a corresponding manner with the record magnetization reversal units according to the exemplary embodiment of the present invention; and

FIG. 5 is a diagram illustrating a conventional magnetic recording and reproducing apparatus.

### REFERENCE MARKS IN THE DRAWINGS

10 magnetic recording medium
11 data domain
12 servo domain
13 magnetic recording layer's continuous area
14 glass substrate
15 soft magnetic back layer
16 under layer
17a, 17b, 17c record magnetization reversal unit
17 continuous magnetic layer
18 non-magnetic layer
19 designated magnetization pattern mark magnetic head
21 recording head
22 main magnetic pole
23 return path
24 coil
25 reproducing head
26 GMR element
27 shield layer
28 traveling direction of magnetic recording medium
29 magnetization pattern
200 measuring unit
31 recording current
32 reproduced signal
41 detecting circuit
42 operation circuit
43 recording current supply circuit
400 detecting unit
410 recording unit

### DETAILED DESCRIPTION OF PREFERRED EMBODIMENTS

Description is provided hereinafter of exemplary embodiments of the present invention with reference to the accompanying drawings.

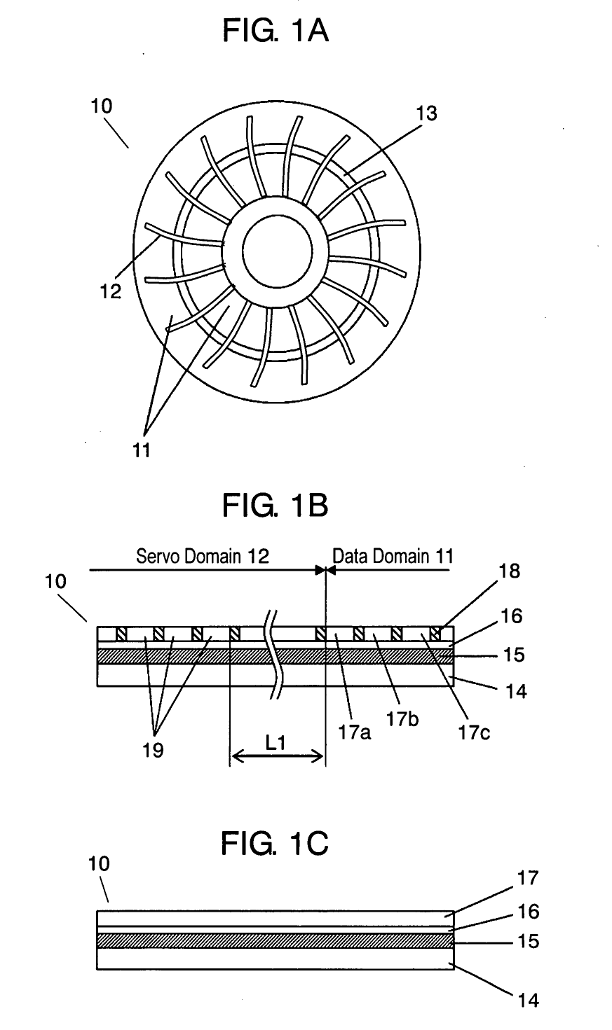

FIG. 1 shows a magnetic recording medium of a magnetic recording and reproducing apparatus according to this exemplary embodiment, wherein FIG. 1A represents a plan view thereof.

Magnetic recording medium 10 comprises data domains 11, servo domains 12, and magnetic recording layer's continuous area 13.

FIG. 1B shows a sectioned general view of magnetic recording medium 10 covering a portion of data domains 11 and servo domains 12, and FIG. 1C shows a sectioned general view of magnetic recording medium 10 in magnetic recording layer's continuous area 13. In servo domains 12 and data domains 11, magnetic recording medium 10 comprises soft magnetic back layer 15 and under layer 16 formed on glass substrate 14, as shown in FIG. 1B. The magnetic recording layer formed on top of under layer 16 is separated by non-magnetic layer 18 to form an array of record magnetization reversal units 17a, 17b and 17c in data domain 11. Although not shown in the figure, record magnetization reversal units, including units 17a, 17b and 17c, are arrayed in the lengthwise direction and the widthwise direction of tracks in the entire area of data domains 11 with non-magnetic layer 18 separating them from one another to provide “patterned media”.

In servo domain 12, designated magnetization pattern marks 19 are at least formed as magnetization reversal units similar to those in the data domain 11 for recording a designated magnetization pattern. These designated magnetization pattern marks 19 may be formed at the same time with the record magnetization reversal units of the data domain, so as to establish distance L1 of a given value accurately from the end of designated magnetization pattern marks 19 to the front of record magnetization reversal unit 17a.

A servo pattern in the servo domain is also comprised of record magnetization reversal units, and it configures a magnetized pattern different from that of designated magnetization pattern marks 19.

In magnetic recording layer's continuous area 13, magnetic recording medium 10 comprises soft magnetic back layer 15 and under layer 16 formed on glass substrate 14 in the like manner as in the data domains and the servo domains, except that the magnetic recording layer differs in configuration from those of the data domains and the servo domains such that it comprises continuous magnetic layer 17, as shown in FIG. 1C.

It is easy to form the magnetic layer of un-separated configuration in magnetic recording layer's continuous area 13 at the same time of forming magnetization reversal units 17a, 17b and 17c, and designated magnetization pattern marks 19, while ensuring precise positioning of continuous magnetic layer 17.

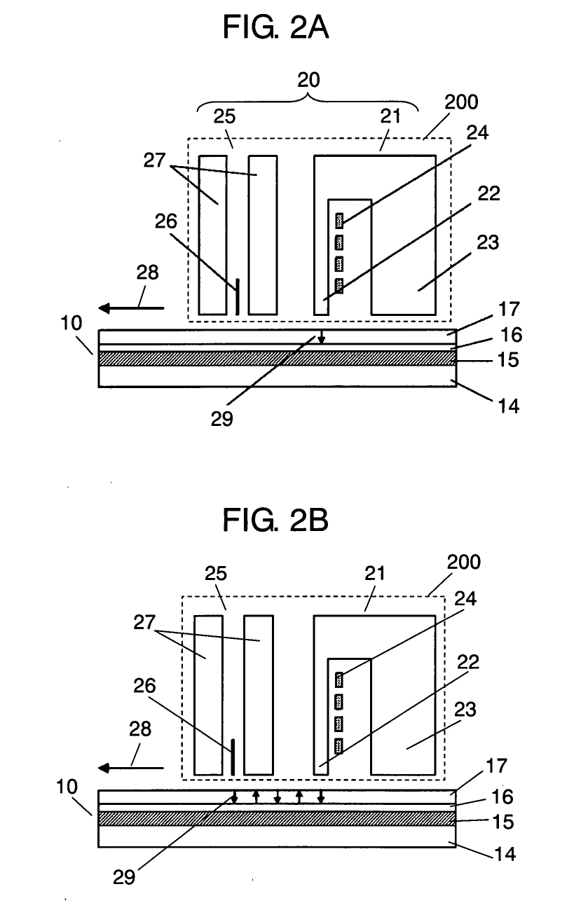

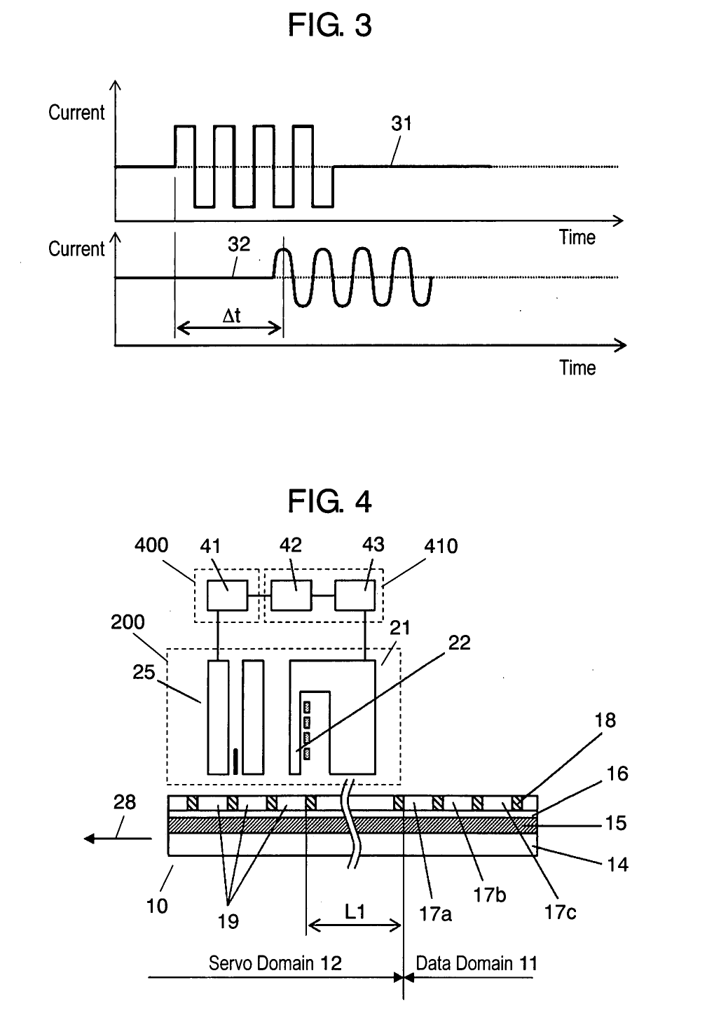

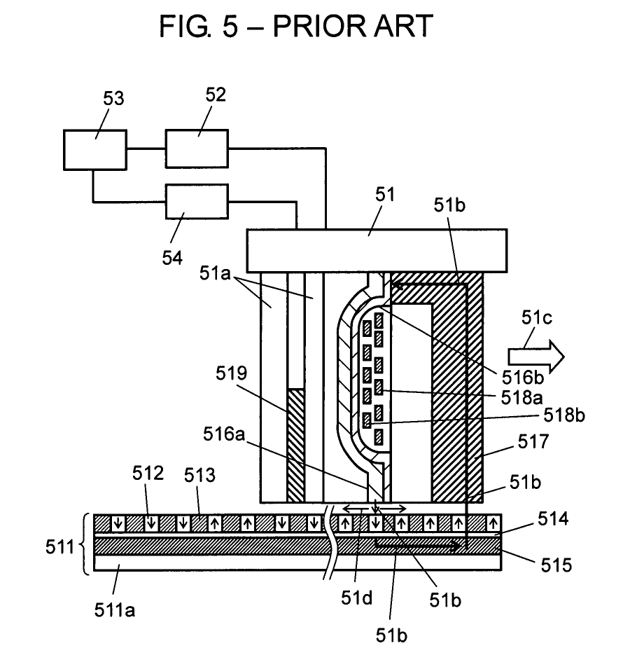

Description is provided next of a structure of measuring unit 200 for measuring a space between a recording head and a reproducing head with reference to FIG. 2 and FIG. 3. Like reference marks are used to designate like components as in FIG. 1.

FIG. 2A and FIG. 2B are general schematics of measuring unit 200 for measuring the space between the recording head and the reproducing head according to this exemplary embodiment of the invention. In FIG. 2A and FIG. 2B, magnetic head 20 is comprised of recording head 21 and reproducing head 25.

Recording head 21 has a magnetic circuit comprised of main magnetic pole 22, soft magnetic back layer 15, and return path 23, wherein a current supplied to coil 24 generates a recording magnetic field in the magnetic circuit to make recording possible in continuous magnetic layer 17.

Reproducing head 25 is a type called shielded MR head which comprises GMR element 26 disposed between shield layers 27, and it reproduces a signal of large amplitude when magnetism recorded in continuous magnetic layer 17 comes directly underneath GMR element 26.

Magnetic recording medium 10 travels in a direction shown by arrow 28. Recording head 21 of magnetic head 20 is located on the upstream side, and reproducing head 25 on the downstream side with respect to the traveling direction of the magnetic recording medium.

Description is provided further of how measuring unit 200 operates. A predetermined recording current is supplied to coil 24 to record a designated magnetization data in continuous magnetic layer 17. A recording magnetic field (not show in the figure) generated by the recording current is impressed on continuous magnetic layer 17 from main magnetic pole 22 to record magnetization pattern 29, as shown in FIG. 2A. Since the magnetic recording medium keeps traveling, reproducing head 25 generates a reproduced signal when magnetization pattern 29 comes close to GMR element 26, and the signal reaches its peak amplitude when magnetization pattern 29 is in a position directly below GMR element 26, as shown in FIG. 2B.

Explanation is continued of this matter by using FIG. 3, which is a graphic representation showing changes with time in amplitude of the recording current and the reproduced signal taken in measuring unit 200 for measuring the space between the recording head and the reproducing head according to this exemplary embodiment of the invention. In this graph, recording current 31 and reproduced signal 32 are shown with duration of time along the axis of abscissas. A difference in time from a moment when recording current 31 is supplied to another moment when reproducing head 25 generates reproduced signal 32 of the peak amplitude is given as delay time Δt in FIG. 3. Delay time Δt is proportional to the space between main magnetic pole 22 and GMR element 26.

Because the magnetic recording medium normally rotates at a constant revolving speed, and a positional relation of continuous magnetic layer 17 is also known precisely in advance, it is quite easy to calculate a traveling velocity of continuous magnetic layer 17. It is therefore possible to determine a spatial distance from main magnetic pole 22 of recording head 21 to GMR element 26 of reproducing head 25 if delay time Δt can be measured.

The delay time Δt in FIG. 3 is defined as the difference between a recording timing and a reproducing timing, as they correspond to the moment of supplying recording current 31 and the other moment of detecting the peak of reproduced signal 35. However, this shall not be not considered as restrictive, and that it is also suitable to use, for instance, a moment of terminating recording current 31 and another moment of detecting cease of reproduced signal 35 to correspond with them.

This measurement may be made at the time of shipment of the magnetic recording and reproducing apparatus, and the result stored in the apparatus. Or, it can be made whenever the electric power to the apparatus is turned on. It is only before the start of recording operation at the latest that the spatial distance from main magnetic pole 22 of recording head 21 to GMR element 26 of reproducing head 25 needs to be known.

It is desirable that continuous recording layer 17 is demagnetized by using recording head 21 before the recording current is supplied to recording head 21 to start the operation of recording in continuous recording layer 17 when measuring the spatial distance between recording head 21 and reproducing head 25, since the demagnetization can improve reliability of the reproduced signal by reproducing head 25.

Described next is detecting unit 400 for detecting a position of the front one of the record magnetization reversal units in data domain 11 by referring to FIG. 4. FIG. 4 is a general schematic showing detecting unit 400 for detecting the position of the front one of the record magnetization reversal units in the data domain and recording unit 410 for recording in a corresponding manner with the record magnetization reversal units according to this exemplary embodiment of the invention.

In the magnetic recording and reproducing apparatus, a servo data is recorded in servo domain 12, and this servo data is used to move magnetic head 20 to a predetermined track in order to record and reproduce data on the predetermined track.

When reproducing head 25 reproduces the servo data, it also reproduces designated magnetization pattern mark 19 written in servo domain 12. Detecting circuit 41 then detects designated magnetization pattern mark 19. Distance L1 from the end of designated magnetization pattern mark 19 to the front record magnetization reversal unit 17a in data domain 11 is specified in advance as described above. In addition, the space between recording head 21 and reproducing head 25, as measured by the above-said measuring unit 200, is fixed by positions of a pattern used in the process of forming the record magnetization reversal units when manufacturing magnetic recording medium 10. A position of the front record magnetization reversal unit in data domain 11 can be thus detected.

Referring now to FIG. 4, description is continued further of recording unit 410 for recording in a corresponding manner with the record magnetization reversal units.

The space between recording head 21 and reproducing head 25, and given distance L1 from the end of designated magnetization pattern mark 19 to the front record magnetization reversal unit 17a in data domain 11 are already known. Therefore, operation circuit 42 can calculate a time required for magnetic recording medium 10 to travel to a position where the front record magnetization reversal unit 17a in data domain 11 moves right under main magnetic pole 22 of recording head 21. It is hence possible to start recording in the front record magnetization reversal unit 17a in the data domain in appropriate timing, when recording current supply circuit 43 supplies a recording current to recording head 21 after the calculated time has elapsed.

As previously described, the record magnetization reversal units are separated by the non-magnetic layer and arrayed in the lengthwise direction as well as the widthwise direction of tracks in the data domains, etc., and continuous magnetic layer 17 is formed in magnetic recording layer's continuous area 13. These magnetization reversal units and continuous magnetic layer are formed in alignment with the center of rotation since the magnetic recording medium is manufactured by a film-forming process using a photolithography technique and the like. A radius and other data of the track, on which recording is to be made can be thus known from the track information included in the servo data. Moreover, magnetic recording medium 10 rotates at a constant revolving speed, which is also known. Therefore, the time required for the front record magnetization reversal unit 17a in data domain 11 to moves right under main magnetic pole 22 can be calculated accurately from the distance L1 between the end of designated magnetization pattern mark 19 in servo domain 12 and the front record magnetization reversal unit 17a in data domain 11, and the space between recording head 21 and reproducing head 25.

In this exemplary embodiment, what has been illustrated is an example of the magnetic recording and reproducing apparatus of the vertical magnetization recording system having a double-layered magnetic recording medium, which comprises a soft magnetic back layer and a magnetic layer. However, the present invention can be embodied in still other ways such as a magnetic recording and reproducing apparatus of the vertical magnetization recording system having a single-layered medium without a back layer and using a recording head of ring type, a magnetic recording and reproducing apparatus of a plane magnetization recording system, or the magnetic recording medium may be a single-layered vertical magnetization recording medium or a plane magnetization recording medium. The apparatus can be composed similarly, and like advantages can be achieved with any such recording medium when provided with data domains, servo domains and a magnetic recording layer's continuous area.

In the above example, the recording layer is separated by the non-magnetic layer into a number of record magnetization reversal units. It can be replaced, however, with patterned media of a double-layered vertical magnetization recording structure, of which a soft magnetic back layer is separated by a non-magnetic layer, and a recording layer formed thereon. The apparatus can be composed similarly and the like advantages can be achieved with such recording medium when provided with data domains, servo domains and a magnetic recording layer's continuous area, as noted above.

### INDUSTRIAL APPLICABILITY

The magnetic recording and reproducing apparatus of this invention comprises the measuring unit for measuring a space between the recording head and the reproducing head, the detecting unit for detecting a position of the front record magnetization reversal unit in the data domain, and the recording unit for recording in a corresponding manner with the record magnetization reversal unit. The invention thus achieves the magnetic recording and reproducing apparatus useful for performing excellent recording on patterned media by virtue of providing a proper timing.

1. A magnetic recording and reproducing apparatus having a magnetic recording medium with a magnetic recording layer, which is separated regularly by a non-magnetic layer into number of record magnetization reversal units and arrayed at least along a lengthwise direction of a recording track, the apparatus comprising:
a measuring unit for measuring a space between a recording head and a reproducing head;
a detecting unit for detecting a position of a front one of the record magnetization reversal units in a data domain; and
a recording unit for recording in a corresponding manner with the record magnetization reversal units.

2. The magnetic recording and reproducing apparatus of claim 1, wherein the measuring unit:
has a magnetic head provided with a recording head on an upstream side and a reproducing head on a downstream side with respect to a traveling direction of the magnetic recording medium having a continuous magnetic recording layer in the lengthwise direction of the recording track;
records a predetermined record pattern on a track carrying the continuous magnetic recording layer with the recording head;
reproduces thereafter the predetermined record pattern with the reproducing head; and
measures the space between the recording head and the reproducing head according to a duration of time therebetween.

3. The magnetic recording and reproducing apparatus of claim 1, wherein the detecting unit detects a designated magnetization pattern mark formed in a servo domain at a given distance apart from the front one of the record magnetization reversal units.

4. The magnetic recording and reproducing apparatus of claim 2, wherein the detecting unit detects a designated magnetization pattern mark formed in a servo domain at a given distance apart from the front one of the record magnetization reversal units.
